(19) United States
(12) Patent Application Publication
(10) Pub. No.: US 2013/0086981 A1
(43) Pub. Date: Apr. 11, 2013

(54) APPARATUS AND METHOD FOR DISCONTINUOUS FILTRATION

(71) Applicants: Stefan Steigmiller, Koeln (DE); Karsten Sommer, Krefeld (DE); Christoph Knappe, Wuppertal (DE)

(72) Inventors: Stefan Steigmiller, Koeln (DE); Karsten Sommer, Krefeld (DE); Christoph Knappe, Wuppertal (DE)

(73) Assignee: BAYER INTELLECTUAL PROPERTY GMBH, Monheim (DE)

(21) Appl. No.: 13/611,488

(22) Filed: Sep. 12, 2012

(30) Foreign Application Priority Data
Sep. 13, 2011 (EP) 11181140.2

(51) Int. Cl. G01N 1/40; B01D 29/56

(52) U.S. Cl. CPC G01N 1/40; B01D 29/56
USPC 73/64.56; 210/295; 210/236; 210/143; 210/806; 210/797; 210/798

(57) ABSTRACT

The invention provides an apparatus for discontinuous filtration of a liquid, having a filter station for filtration, a feed line for supplying the liquid to the filter station, and a filter medium movable relative to the station, the filter medium comprising at least two different membranes, which together in the filter station effect multistage filtration. The invention additionally relates to a method for discontinuous filtration of a liquid or for filtering isolated quantities of liquid, comprising: providing a filter station for filtration, the filter station comprising a chamber in which filtration is carried out; moving or transporting a filter medium from a stock into the filter station, the filter medium comprising at least two membranes which are arranged next to one another in the chamber; and supplying the liquid to the chamber, such that the liquid is subjected to multistage filtration through the membranes.

### CROSS REFERENCE TO RELATED APPLICATIONS

This application claims priority to EP Application 11181140.2 filed Sep. 13, 2011 the entire contents of which are hereby incorporated by reference in its entirety.

### BACKGROUND

1. Field of the Invention

The present invention relates to an apparatus and a method for discontinuous filtration and is used in particular in process analysis technology in biotechnological processes, for example in the automated sampling of liquids with subsequent sample preparation. However, the present invention is not restricted to applications in the field of biotechnology. Rather, the present invention may be used advantageously in multiple different processes in which automated, discontinuous filtration is needed.

2. Description of Related Art

An automation platform for fully automated liquids sampling, transport, sample preparation and subsequent analysis is known for example from EP 1439472 A1 and EP 2013328 A2. These devices are used inter alia in the automation of analysers in biotechnological processes, for example in cell culturing. In cell culturing, full samples are taken as standard, these containing cells and cell particles. Fully automated sampling and analysis of biological culturing processes over short time periods offers the possibility of early recognition of fluctuations in the variable growth process of cells and micro-organisms in industrial culturing and of taking appropriate measures. A particle-containing full sample allows a plurality of analytical methods to be carried out. However, for the procedures used in them, some of these methods need just the particle-free part of the full sample. These analytical methods include for example analysis of the culture medium with optical measurements or liquid chromatography, in order to be able to qualify and/or quantify a plurality of starting and product materials.

In many culturing processes, only a small volume of full sample is available (for example in the region of 1 to 50 ml), which has then to be efficiently subdivided for analysis. Therefore, only part of said sample can also be used for particle separation. In the case of fully automated automation platforms with sampling and subsequent analysis, the intention is to operate such systems automatically for a week without human intervention. For the fully automatic filtration required in this case of small volumes of particle-containing liquids, there are few suitable methods available which combine a high particle retention rate with simultaneously small liquid losses, system robustness and short filtration step processing time.

For automated filtration of biological samples from culturing processes, an apparatus is known which carries out compressed air filtration of a sample using a flat membrane. However, this exhibits the major problem that the volume of filtrate in the dynamic culturing process decreases significantly as the particle number increases. At higher particle densities it is no longer possible to produce a sufficient quantity of filtrate from the sample volume provided. In addition, this prior art apparatus does not fulfil the general requirements for hygiene when handling cells and micro-organisms. The long transport path through the apparatus may result in the filter cake leaving behind cell residues, some of which have major contamination potential.

When using the filter technology in an automated environment with varying samples, it is likewise essential to rule out the transfer of sample constituents to subsequent filtration operations or for this to occur only to a greatly reduced extent, so as to rule out product entrainment or product transfer. This is particularly necessary when culturing cells for the production of drugs using Good Manufacturing Practice (GMP), since in this case validation is required which provides evidence that product entrainment or product transfer have been ruled out.

### SUMMARY

It is therefore an object of the invention to provide an apparatus and a method which may produce, preferably (fully) automatically, a sample which is particle-free down to the filter cut-off size, for example without cells or cell fragments, at the same time as exhibiting low losses and short processing times. In addition, requirements for robustness and reliability should be met, both in the field of Research & Development and in production environments. It is a further object to provide an apparatus and a method in which transfer of sample constituents to subsequent filtration operations is either ruled out or can only occur to an insignificant extent.

This object is achieved according to the invention by an apparatus for discontinuous filtration of a liquid having the features of Claim 1 and by a method having the features of Claim 10. Preferred embodiments of the invention are mentioned in the subclaims.

### BRIEF DESCRIPTION OF THE DRAWINGS

FIG. 1 depicts an embodiment of the present invention.

### DETAILED DESCRIPTION OF A PREFERRED EMBODIMENT

According to one aspect of the invention, an apparatus for discontinuous filtration of a liquid is provided, having a filter station for carrying out filtration, a feed line for supplying a desired quantity of the liquid to be filtered to the filter station, and a filter medium movable relative to the filter station, the filter medium comprising at least two different membranes, which together effect multistage filtration in the filter station. Multistage filtration means that the liquid to be filtered undergoes or is subject to at least two filtration stages, preferably comprising a first, coarser filtration stage and a second, finer stage.

In this way, a virtually particle-free sample may be ensured, with relatively low liquid loss and short processing time. The inventors have noted that multistage filtration for example with coarser preliminary filtration and finer final filtration reduces processing time and liquid loss significantly. Even if a plurality of membranes lie one on top of the other, filtration takes places in several stages.

In a preferred embodiment of the invention, the filter medium comprises a first membrane and a second membrane, each of which membranes forms a respective filtration stage. The membranes may be arranged one over the other in the filter station, the membranes preferably being flat membranes, and the first membrane being arranged over or on the second membrane in the filter station.

In a preferred embodiment of the invention, the first membrane has a higher average or nominal pore size than the second membrane and is arranged upstream of the second membrane, such that the first membrane may effect preliminary filtration of the liquid. The first membrane may thus form a first (preliminary) filtration stage, and the first membrane may act as a surface filter and/or as a deep-bed filter, preferably for filtration of cells. The second membrane, on the other hand, forms a finer, optionally final filtration stage, which may act as a surface filter and/or as a deep-bed filter, preferably for filtration of cell fragments. A filter cake may form on both membranes, which could be washed and dried in a further preferred embodiment for further processing or analysis. The first membrane may thereby trap larger particles or cells, while smaller particles and/or cell fragments pass through the first membrane. The preliminarily filtered liquid then comes into contact with the second membrane, which traps the smaller particles or cell fragments and allows through a then virtually particle-free liquid sample. Filtration by the second, fine-pore membrane is therefore preceded by a first membrane, which, with a different particle cut-off size from the first filtration membrane, enlarges the filtrate volume decisively compared with the prior art in the case of high particle density. Thus, the second membrane is responsible for the required separation rate and filtrate quality.

Preferably, the first membrane and the second membrane are separate components, which are brought together or combined either in or shortly before the filter station. In the present invention special filtration membranes are selected and used, which meet both the chemical requirements of a quantitative analysis and the structural/mechanical requirements for a stable, automated filtration cycle. The materials and properties of the respective membranes are therefore selected to match the specific requirements. Thus, the first and second membranes may for example be hydrophilic or hydrophobic, or one of each, depending on the application.

In a preferred embodiment of the invention, the membranes are kept available or held in stock in or on the apparatus, such that clean or unused membranes are available for each filtration operation. In addition, the apparatus comprises transportation means for moving or guiding the membranes from the stock into the filter station, the transportation means also preferably moving or guiding the membranes out of the filter station after filtration. The stock typically comprises a first stock-holding unit for the first membrane and a second stock-holding unit for the second membrane. Both the first and the second membrane are preferably designed as strips, such that the first stock-holding unit may be designed as a first roll or coil and the second stock-holding unit as a second roll or coil. In other words, the at least two membranes are preferably held in stock in rolls or coils. The width of the strip used is selected in accordance with the structural/mechanical requirements for a stable, automated filtration cycle. By arranging the filtration membranes on different rolls or coils, adaptation to different particle sizes may be achieved while maintaining the same filtration result by replacing the top or first filtration strip. Greater flexibility over the range of applications is thereby ensured.

As biotechnological processes, such as for example fermentation, progress, the number of cells or micro-organisms in the liquid to be filtered may change or increase greatly over time, which led in the prior art to severe impairment of the filtration result. With the present invention, however, good filtration results may be reliably ensured even with a strongly growing number of cells or micro-organisms.

In a preferred embodiment of the invention, the transportation means is configured such that it takes the membranes separately from the stock and guides them together to the filter station. The transportation means may preferably also remove the membranes from the filter station after filtration. The transportation means comprises at least one motor, in particular an electric motor (for example a stepping motor), which transports the first and second membranes into the filter station. If the first and second membranes are stored in the stock on rolls, the at least one motor may either drive these rolls directly and/or draw the membranes off these rolls. In one particularly preferred embodiment of the invention, the portions of the membranes used in the filter station are wound onto a collecting roller after filtration. Therefore, the at least one motor may drive the collecting roller directly (discontinuously) and draw the membranes at the same time off the stock-holding rolls into the filter station for the next filtration run.

In one preferred embodiment of the invention the filter station comprises a chamber in which the filtration is carried out. The chamber is located in a housing, which comprises at least one mobile housing part, through movement of which the chamber or the housing may be opened and/or closed. The chamber or the housing is closed for carrying out filtration, and is opened to remove the used membranes from the chamber or to transport clean or unused membranes into the filter station or into the chamber. The chamber preferably has a shape which assists in or brings about distribution of the supplied liquid over the entire surface area of the filter medium in the chamber, in particular such that the liquid is filtered substantially evenly over the filter medium. The shape of the chamber is preferably conical, with an opening angle preferably in the range between 90° and 180°, more preferably in the range between 120° and 180° and still more preferably in the range between 150° and 180°. The volume of the chamber is preferably markedly smaller than a volume or the quantity of liquid to be filtered, for example one or indeed two orders of magnitude smaller. The feed line is therefore preferably configured to supply the desired quantity of liquid to the chamber during filtration. The feed line may thus feed the desired quantity of liquid, for example under pressure, continuously into the chamber and thereby promote filtration through the filter medium.

In a preferred embodiment of the invention, the filter station additionally comprises a supporting structure, which supports the filter medium in the filter station and thereby prevents deformation of the membranes during filtration. The supporting structure counteracts mechanical loading of the filter medium at high particle density, such that plastic deformation of the membranes may be kept as low as possible during filtration. Such deformation may lead to damage to and tears in the membrane during transport of the strip, which in turn has a serious negative impact on system running time and on the robustness, accuracy and reliability of the subsequent analysis. Furthermore, the supporting structure increases filtration capacity or particle cut-off rate, since deformation of the membrane pores due to plastic modification in the structure is counteracted.

In one preferred embodiment of the invention, the apparatus further comprises a control system, which controls or monitors the area or length of the filter medium transported into the filter station. In this connection, the control system comprises at least one sensor, which monitors or detects the length of the membranes or membrane portions transported into the filter station. The at least one sensor, preferably at least two sensors, of the control system may monitor or detect rotation of the stock-holding rolls and thereby control movement of the membranes by the transportation means. In addition, the control system may preferably control supply of the desired quantity of liquid to be filtered to the filter station or to the chamber. In addition, the control system may also control opening and closing of the filter chamber or of the housing, such that filtration may be fully automated as a discontinuous, dead-end or batch method for individual, isolated quantities of liquid.

According to another aspect of the invention, the apparatus as described above may be incorporated into a fully automated or semi-automated automation platform, preferably as a modular unit. This platform takes on sampling from processes, preferably from bioreactors for culturing cells, and preparation thereof. After particle separation by means of discontinuous filtration using the apparatus as described above, various analytical methods (e.g. cell counting, media analysis, product quantification, product quality) are preferably combined in the system. In addition, the apparatus as described above may be simply incorporated into the control system of the automation platform and is preferably recognised automatically thereby as an apparatus. The invention therefore provides a system for analysing processes, in particular biological processes such as for example culturing processes, the system comprising an apparatus, which may be configured and further developed as described above, for discontinuous filtration of a liquid or for filtration of isolated quantities of a liquid. The system is preferably automated, such that filtration for preparing a sample may be performed with the apparatus at predetermined intervals.

According to a further aspect of the invention, a method for discontinuous filtration of a liquid or for filtering isolated quantities of liquid is provided, having the following steps: providing a filter station for carrying out filtration, the filter station comprising a chamber in which filtration is carried out; moving or transporting a filter medium from a stock into the filter station, the filter medium comprising at least two membranes, preferably flat membranes, which are arranged next to one another in the chamber; and supplying a desired quantity of the liquid to be filtered to the chamber, such that the liquid is subjected to multistage filtration through the membranes.

In a preferred embodiment of the invention, the chamber is located in a housing, which comprises at least one movable housing part, in order to open or close the chamber, and the method comprises the following steps: opening the chamber for movement or transport of the filter medium into the filter station; closing the chamber to carry out the filtration; and removing or drawing off the filtered liquid from the chamber during filtration of the desired or isolated quantity of liquid.

In one preferred embodiment of the invention the at least two membranes are taken separately from the stock and brought together or combined either in or shortly before the filter station. In one particularly preferred embodiment of the invention the membranes take the form of strip-form flat membranes, which are stored on respective rolls in the stock and the method comprises the following further step: controlling the length of the membranes which are transported off the rolls from the stock into the filter station for filtration.

In a preferred embodiment of the invention, the method comprises the following further step: flushing the chamber with a cleaning liquid, once multistage filtration has been carried out on the supplied liquid. Flushing of the chamber comprises the following steps: opening the chamber and moving the used filter medium out of the chamber or out of the filter station; closing the chamber and feeding the cleaning liquid through the chamber, to remove residues of the liquid to be filtered, flushing preferably comprising back-flushing of the chamber, in which the cleaning liquid flows through the chamber in the opposite direction to filtration.

In a preferred embodiment of the invention, the method comprises the following further step: distributing the supplied liquid over the entire surface area of the filter medium in the chamber, such that the liquid is filtered substantially evenly over the filter medium. Distribution of the supplied liquid is preferably brought about by the shape of the chamber.

The invention is explained by way of example below with reference to the attached drawing and to preferred exemplary embodiments, wherein the features explained below may each represent one aspect of the invention, either individually or in combination. In the drawing:

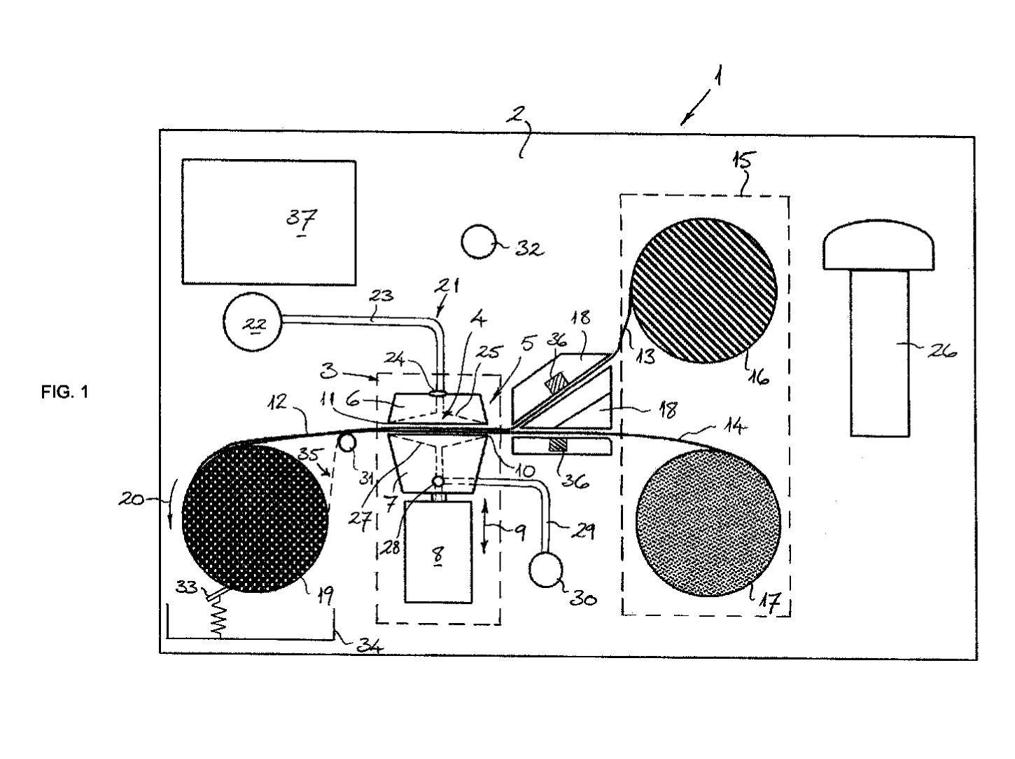

FIG. 1: is a schematic representation of an apparatus according to the invention for discontinuous filtration or for filtration of isolated quantities of liquid.

The apparatus 1 shown in FIG. 1 for discontinuous dead-end filtration of a liquid is of modular construction and fastened in a box 2 with the assistance of metal plates, in particular aluminium plates. The apparatus 1 comprises a filter station 3 (shown as a dashed box) for carrying out discontinuous filtration, the filter station 3 comprising a chamber 4, in which filtration is carried out. The chamber 4 is located in a closable housing 5, which consists in this exemplary embodiment of an upper housing part 6 and a lower housing part 7. The lower housing part 7 is connected to a lifting drive 8, which may move the lower housing part 7 up and down in the vertical direction 9, in order either to close or open the housing 5 and with it also the chamber 4. If the lifting drive 8 moves the housing part 7 vertically upwards, an outer edge 10 of the lower housing part 7 is pressed against an outer edge 11 of the upper housing part 6 and the chamber 4 is thereby closed. A seal may be provided at the edges 10, 11 between the housing parts 6, 7 by an annular sealing element of steel, stainless steel, silicone, PTFE, PFA, PEEK, EPDM, Viton®, preferably of fluoroelastomers or rubber. If the housing part 7 is then moved by the lifting drive 8 vertically downwards back into the position in FIG. 1, the chamber 4 is re-opened. This bringing together of the housing parts 6, 7 may be performed for example by a magnetic, pneumatic or preferably electrical drive 8.

In addition, the apparatus 1 comprises a filter medium 12 movable relative to the filter station 3, which filter medium consists in this exemplary embodiment of a first upper membrane 13 and a second lower membrane 14. The first membrane 13 has a higher average or nominal pore size (for example in the range from 1 to 200 μm) than the second membrane 14 (for example in the range from 0.01 to 2 μm) but each membrane 13, 14 is a flat membrane and takes the form of a strip of a width in the range from approx. 2 to 200 mm, preferably from approx. 30 to 50 mm. The first and second membranes 13, 14 are stored on respective rolls 16, 17 in a stock 15 and are brought together off the rolls 16, 17 out of the stock 15 into the filter station 3 through a guide element 18 in such a way that the first membrane 13 is arranged on the second membrane 14 in the chamber 4. The filter membranes 13, 14 extend in and through the chamber 4 and are wound together onto a collecting roll 19, or in a further preferred embodiment (not shown) individually and separately onto a plurality of collecting rolls. The collecting roll 19 is driven periodically by a stepping motor (not shown) in the direction 20, when the housing 5 is opened, which in turn then draws the two membranes 13, 14 simultaneously out of the stock 15 and transports them together into the filter station 3 or into the chamber 4.

When the housing 5 is closed, the chamber 4 is sealed at the edges 10, 11 by the housing parts 6, 7 being brought together mechanically, such that the first and second membranes 13, 14 may then effect two-stage filtration in the chamber 4. To this end, the apparatus 1 comprises a feed line 21 for supplying a desired quantity of the liquid to be filtered to the filter station 3, the feed line 21 comprising a valve 22 and a hose 23, which may feed the liquid to be filtered into the chamber 4 via an inlet 24 of the upper housing part 6. Since the apparatus 1 has been designed as a component of an automation system for the analysis of biological culturing processes, it is used to separate biological particles, preferably cells or unicellular organisms (bacteria, yeasts, cell culture cells, plant cells, algae, etc.), which are used for culturing processes. A desired or predetermined quantity of the liquid to be filtered is thus removed automatically at predetermined time intervals from the culturing process and fed for sample preparation via the feed line 21 into the closed chamber 4, where the biological particles or cells and cell fragments are separated from the sample by the filter medium 12.

In the upper housing part 6 the chamber 4 is conical or cone-shaped in design 25 with a very flat opening angle in the range between 150° and 180°, which assists in or brings about distribution of the supplied liquid over the entire surface area of the filter medium 12 in the chamber 4. Thus, the liquid may be filtered substantially evenly over the filter medium 12. The size of the filter area may be configured according to the application by the structure of the housing 5. In this exemplary embodiment, the filter area is greater than 4 cm², for example in the range of 5 to 10 cm². The volume of liquid supplied in this exemplary embodiment is approx. 20 ml, the volume of the chamber 4 amounting in the upper housing part 6 to approx. just 1 ml. If the liquid is conveyed by means of a burette drive 26 (or alternatively by means of a peristaltic pump or similar pumps) into the chamber 4, it is therefore also simultaneously passed through the two membranes 13, 14. Thus, the feed line 21 may feed the desired quantity of liquid under pressure (for example in the range of 1 to 2 bar) continuously into the chamber 4 and thereby promote filtration through the filter medium 12. In the lower housing part 7 the chamber 4 is also of conical or cone-shaped design 27 (inverted relative to the upper part) with a volume of approx. 1.5 ml, where the now filtered liquid is removed or drawn off from the filter station 3 via an outlet 28, a hose 29 and a valve 30. This conical design 27 of the lower part 7 assists in or promotes collection and draining away of the liquid, and in a preferred embodiment the burette 26 assists the filtration process by drawing off the filtrate.

The first and second membranes 13, 14 each form one filtration stage for the liquid supplied. More precisely, the first membrane 13 serves for preliminary filtration, trapping larger particles and cells while smaller particles and cell fragments pass through the first membrane 13. The preliminarily filtered liquid then comes into contact with the second membrane 14, which traps the smaller particles or cell fragments and allows a virtually particle-free liquid sample through to the outlet 28. Although not explicitly shown in FIG. 1, a supporting structure is fixedly installed or inserted in the lower housing part 7, which structure protects the membranes 13, 14 against deformation during filtration and also serves in subsequent transport of the filter medium 12. The supporting structure may take the form of a supporting element and extends right over the filter area (preferably in the plane of the filter membranes) as a grid or open frame, which counteracts mechanical loading of the filter medium 12 in the case of a high particle density in the liquid, so as to keep plastic deformation of the membranes 13, 14 during filtration low and prevent tearing of the membranes 13, 14.

Once the isolated quantity of liquid to be filtered by the filter station 3 has undergone multistage filtration, the lifting drive 8 is actuated, to open the housing 5. The collecting roll 19 is then driven in the direction 20, to draw the filter medium 12, which has now been used and is spent, out of the filter station 3—preferably to beyond a supporting roll 31 outside the filter station 3—and thereby also to move clean, unused flat membranes 13, 14 through the guide element 18 into the filter station 3. The chamber 4 or the housing 5 is then closed again by way of the lifting drive 8 and a flushing operation is performed to flush the chamber 4 with a flushing solution. The flushing takes the form of back-flushing, in which the cleaning solution flows or is conveyed via a flush valve 32 and the outlet 28 backwards from the lower housing part 7 through the new filter medium 12 and through the chamber 4 into the upper housing part 6. In this way, the residues of the particles, cells and liquid are removed from the chamber 4, to ensure that transfer of sample constituents to subsequent filtration operations and thus product entrainment or product transfer is ruled out. After this flushing operation with a suitable volume of cleaning liquid (for example in the range from 1 to 50 ml, preferably 5 ml), the housing 5 is re-opened and the filter medium 12 is wound to the same extent further onto the collecting roll 19, until clean, unused flat membranes 13, 14 are once again ready in the station 3 for the next filtration run.

The particles and cells or cell fragments which remain on the filter medium 12 as filter cake are wound onto the collecting roll 19 together with the used flat membranes 13, 14. In addition, after a filtration run the filter cake may be collected in a receptacle 34 designed therefor via a cleaning device 33 (for example scraper blade or brush, possibly spring-mounted). Alternatively, by means of another guide 35 for the spent filter medium 12, the filter cake could be additionally enclosed in the strip already present on the collecting roll 19, so further reducing the risk of soiling and contamination.

Advance of the filter membranes 13, 14 into the filter station 3 is brought about by the stepping motor, which drives the collecting roll 19. It may therefore be expected that the filter membranes 13, 14 are moved and brought together relatively precisely. Nevertheless, the apparatus 1 also comprises sensors 36, which perform monitoring or control of advance of the two membranes 13, 14 by contactless, optical reflection measurement. In addition, the apparatus 1 may comprise further sensors (not shown), which are mounted on the shafts of the two stock-holding rolls 16, 17 and monitor or control the angle of rotation of these rolls. As already mentioned above, the apparatus 1 is fully automated, with an in-built control system accommodated in the box 2. A display 37 with driver is preferably installed in a front plate of the box 2, to simplify operation of the apparatus 1.

### LIST OF REFERENCE SIGNS

1 Apparatus
2 Box
3 Filter station
4 Chamber
5 Housing
6 Upper housing part
7 Lower housing part
8 Lifting drive
9 Directions of the lifting movements
10 Edge of the lower housing part
11 Edge of the upper housing part
12 Filter medium
13 First membrane
14 Second membrane
15 Stock
16 First stock-holding roll
17 Second stock-holding roll
18 Guide element
19 Collecting roll
20 Direction of rotation of the collecting roll
21 Feed line
22 Valve
23 Hose
24 Inlet
25 Conical design of chamber in upper housing part
26 Burette drive
27 Conical design of chamber in lower housing part
28 Outlet
29 Hose
30 Valve
31 Supporting roll
32 Flush valve
33 Cleaning device
34 Receptacle
35 Alternative guide for filter membranes
36 Sensor
37 Display

1. Apparatus for discontinuous filtration of a liquid comprising: a filter station for carrying out filtration, a feed line for supplying a desired quantity of the liquid to be filtered to the filter station, and a filter medium movable relative to the filter station, wherein the filter medium comprises at least two different membranes, which together effect multistage filtration in the filter station.

2. Apparatus according to claim 1, wherein the filter medium comprises a first membrane and a second membrane, each of said membranes forming a respective filtration stage, the first and second membranes optionally being flat membranes and arranged next to one another in the filter station.

3. Apparatus according to claim 2, wherein the first membrane has a higher average and/or nominal pore size than the second membrane and is arranged upstream of the second membrane, such that the first membrane may effect preliminary filtration of liquid.

4. Apparatus according to claim 2, wherein the first membrane and the second membrane are separate components, which can be brought together and/or combined with one another either in or shortly before the filter station.

5. Apparatus according to claim 1, wherein the membranes are kept available and/or held in stock in or on the apparatus, such that clean and/or unused membranes are available for each filtration operation, wherein the apparatus further comprises transportation means for moving and/or guiding the membranes out of stock into the filter station, wherein the transportation means optionally moves and/or guides the membranes out of the filter station after filtration.

6. Apparatus according to claim 5, wherein the transportation means is configured such that said transportation means takes the membranes separately out of stock and guides said membranes together into the filter station and optionally removes said membranes from the filter station after filtration.

7. Apparatus according to claim 1, further comprising a control system, which can control area and/or length of the membranes responsible for multistage filtration in the filter station.

8. Apparatus according to claim 1, wherein the filter station comprises a chamber, in which filtration is carried out, and wherein the chamber is of a shape which can assist with and/or effect distribution of supplied liquid over an entire surface area of the filter medium in the chamber, such that liquid can be filtered substantially evenly over the filter medium, wherein a shape of the chamber is optionally conical, with an opening angle optionally in a range from 90° to 180°, optionally in a range from 120° to 180°.

9. Apparatus according to claim 1, wherein the filter station further comprises a supporting structure, which can support the filter medium and can counteract deformation and/or a tearing of the membranes during filtration.

10. Method for discontinuous filtration of a liquid and/or for filtration of isolated quantities of liquid, said method comprising:
providing a filter station for carrying out filtration, wherein the filter station comprises a chamber, in which filtration can be carried out;
moving and/or transporting a filter medium from a stock into the filter station, wherein the filter medium comprises at least two membranes, optionally flat membranes, which are arranged next to one another in the chamber; and
supplying a desired quantity of liquid to be filtered to the chamber, such that the liquid is subject to multistage filtration through the membranes.

11. Method according to claim 10, wherein the chamber is located in a housing, which comprises at least one movable housing part in order to open and/or close the chamber, and wherein the method further comprises:
opening the chamber for movement and/or transport of the filter medium into the filter station;
closing the chamber to carry out filtration; and
removing and/or drawing off filtered liquid from the chamber during filtration of a desired and/or isolated quantity of liquid.

12. Method according to claim 10, wherein the at least two membranes of the filter medium are taken separately from the stock and brought together and/or combined either in or shortly before the filter station.

13. Method according to claim 12, wherein the membranes take a form of strip-form flat membranes, which can be stored on respective rolls in the stock, and wherein the method further comprises:
controlling a length of the membranes which are transported off the rolls from the stock into the filter station for filtration.

14. Method according to claim 10, further comprising:
flushing the chamber with a cleaning liquid, once supplied liquid has been subjected to multistage filtration, wherein flushing of the chamber comprises:
opening the chamber and moving the filter medium used out of the chamber and/or out of the filter station;
closing the chamber and feeding cleaning liquid through the chamber, to remove residue of liquid to be filtered,
wherein flushing optionally comprises back-flushing of the chamber, in which flushing liquid flows through the chamber in an opposite direction to filtration.

15. System for analysing processes, optionally biological processes, wherein the system comprises a fully automated or semi-automated automation platform, in which an apparatus for discontinuous filtration according to claim 1 is incorporated, wherein the apparatus optionally takes the form of a modular unit.
